(19) United States
(12) Patent Application Publication
(10) Pub. No.: US 2020/0387836 A1
(43) Pub. Date: Dec. 10, 2020

(54) MACHINE LEARNING MODEL SURETY

(71) Applicant: Accenture Global Solutions Limited, Dublin (IE)

(72) Inventors: Mohamad Mehdi Nasr-Azadani, Menlo Park, CA (US); Matthew Kujawinski, San Jose, CA (US); Andrew Nam, San Francisco, CA (US); Yao Yang, San Francisco, CA (US); Teresa Sheausan Tung, Tustin, CA (US); Jurgen Albert Weichenberger, Woking, Surrey (GB)

(21) Appl. No.: 16/891,980

(22) Filed: Jun. 3, 2020

Related U.S. Application Data
(60) Provisional application No. 62/856,904, filed on Jun. 4, 2019.
(60) Provisional application No. 62/963,961, filed on Jan. 21, 2020.
(60) Provisional application No. 62/966,410, filed on Jan. 27, 2020.

(51) Int. Cl. G06N 20/20

(52) U.S. Cl. CPC G06N 20/20

(57) ABSTRACT

Complex computer system architectures are described for providing a machine learning model management tool that monitors, detects, and makes revisions to machine learning models to prevent declines and maintain robustness and fairness in machine learning model performance in production over time. The machine learning model management tool achieves its goals via intelligent management, organization, and orchestration of detection, inspection, and correction engines.

### CROSS REFERENCES

This application claims priority to U.S. Provisional Patent Application No. 62/856,904 filed on Jun. 4, 2019, U.S. Provisional Patent Application No. 62/963,961, filed on Jan. 21, 2020, and U.S. Provisional Patent Application No. 62/966,410, filed on Jan. 27, 2020, the entirety of which are incorporated herein by reference.

### TECHNICAL FIELD

This disclosure relates to monitoring, detecting, analyzing, and revising machine learning models in production.

### BACKGROUND

Machine learning models are applied to automate tasks previously attributed to humans with increasing efficiency and accuracy. The machine learning models are developed with a number of assumptions about how they will operate in production. However, there are risks that these assumptions may be violated, whether by operational, software/hardware, unknown circumstances, or by intentional adversarial attacks from outside sources that are attempting to manipulate the results of the machine learning models.

The presently disclosed features look to address these technical problems and to increase accuracy, fairness, and robustness in the performance of machine learning models in production.

### BRIEF DESCRIPTION OF THE DRAWINGS

FIG. 1 illustrates functional components of a machine learning surety management platform.

FIG. 2 shows an example machine learning pipeline with and without detection and inspection components.

FIG. 3 shows an example machine learning surety pipeline along with a correction circuitry.

FIG. 4 shows an example correction circuitry including data processing components, a correction engine, and a model catalog.

FIG. 5 shows an example machine learning model surety management system including an online machine learning model production pipeline and an on-demand correction pipeline.

FIG. 6 shows an example machine learning model surety management system using ensemble detection and ensemble production machine models from a model school.

FIG. 7 shows an example production machine learning model ensemble.

FIG. 8 shows an example block diagram for model school training and generation.

FIG. 9 shows and example ensemble detector.

FIG. 10 illustrates an example of an appropriate gender relationship in a feature space of a machine learning model.

FIG. 11 illustrates an example of an inappropriate or biased gender relationship in a feature space of a machine learning model.

FIG. 12 illustrates an example correction for a biased gender relationship in a feature space of a machine learning model.

FIG. 13 illustrates an example of creating of feature subspace for correcting biased gender relationship in a feature space of a machine learning model.

FIG. 14 shows an example architecture for a computer device used to implement the features of the machine learning model surety management system.

FIG. 15 shows an example architecture for a monitoring tool included in the machine learning model surety management tool.

### DETAILED DESCRIPTION

Lifecycles of machine learning models involve interconnecting tasks such as defining, data collection, building, testing, deploying, monitoring, evaluating, retraining, and updating the machine learning models. Effective lifecycle management of machine learning models in a production environment poses a technical challenge on multiple disciplinary levels and requires an integration of a diverse skillset including but not limited to business intelligence, domain knowledge, machine learning and data science, data ETL (extract/transform/load) techniques, software development, DevOps (software development (Dev) and information technology operations (Ops)), and QA (quality assurance). As such, lifecycle management of a machine learning model usually requires complex processes involving a diverse group of computer engineers, domain experts, software developers, and/or data scientists.

A lifecycle of a machine leaning model begins with its initial definition and development by data scientists and domain experts. Depending on the types of input data and types of prediction tasks and outputs, the machine learning model may be first architected to include various choices of machine learning algorithms. A training dataset may be collected/generated, processed, and labeled. The machine learning model may then be trained using the training dataset. The trained machine learning model may include one or more data processing layers embedded with model parameters determined during the training process. The trained machine learning model may then be further tested before being provided to a production environment.

As an additional important part of the lifecycle of a trained machine learning model, its predictive performance may be further continuously monitored and evaluated while it is being deployed in the production environment. Based on such continuous monitoring and evaluation, a retraining of the machine learning model may be triggered when needed and then the retrained machine learning model may be retested/reevaluated and updated in the production environment. Such a monitoring, evaluation, retraining, reevaluation and updating process provide some degree of surety, reliability, and safety in the performance of the machine learning model in the production environment.

Many practical industrial, enterprise, and other applications require a large number of interconnecting machine learning models integrated into a single complex data analytics and/or information/signal control system. In a particular example of a sensor network application, thousands of real-time machine learning models may be integrated in a framework for collecting data from tens of thousands or more distributed sensors and for performing real time predictive data analytics. Such a framework for machine learning models, for example, may be adapted in an application for use in an industrial plant for analyzing various real time sensor outputs and generating real time control signals to a large number of components of the plant based on predictions from the machine learning models. For these complex applications, the development, deployment, monitoring/evaluation, retraining, reevaluation, and updating of the large number of machine learning models to provide improved surety in the predictive performance and model safety present a daunting task and can only be effectively achieved with at least some degree of automation. The disclosure below describes various implementations of such an automated framework and technical components therein for developing, deploying, monitoring/evaluating, retraining, reevaluating, and updating machine learning models. Such a framework may be referred to as a machine learning model management framework (MLMM framework).

The term “model surety” is used in this disclosure to broadly represent various aspects of the automated model development, deployment, monitoring, evaluation, retraining, reevaluation, and updating in the MLMM framework for ensuring that a machine learning model generates predictions that are reasonably accurate, fair, robust, and safe in the production environment and during its lifecycle. These aspects may include but are not limited to:
Explainability and fairness. For example, the machine learning models may be monitored by the MLMM framework such that the model performance is quantified with explainable reasons of any performance issues. For another example, the MLMM framework may quantify sensitivities and feature importance in a machine learning model via performance monitoring. The MLMM framework may further ascertain bias in the predictions of the machine learning model for facilitating processing of training dataset and model assumptions in retraining to remove or reduce the detected bias. Further, the automated MLMM framework may contain technical components for identifying and quantifying relationship in the dataset to provide explainability to the monitored performance issues of the machine learning model.
Responsibility. For example, the automated MLMM framework may provide technical components for automatic traceability and reproducibility of the machine learning models, and for reliable data storage for the management of the machine learning model lifecycles. For another example, the automated MLMM framework may provide technical components for analyzing the development of the machine learning models to remove bias and imbalance in the training dataset, the selection of machine learning and/or data analytics algorithms, model architectures, and human model interpretations. Further, the automated MLMM framework may provide intelligent monitoring, testing, and correction of other different ETL and machine learning pipeline components used in the automated machine learning model lifecycle framework.
Robustness. For example, the automated MLMM framework may provide technical components for detecting missing input data, out-of-range data values, noisy input data, and unexpected types of input data. For another example, the automated MLMM framework may further provide technical components for identifying known and unknown adversarial attacks on the machine learning models. For another example, the automated MLMM framework may provide technical components for identifying unpredicted temporal changes in data compositions. For yet another example, the automated MLMM framework may provide technical components for detecting and identifying trends in demographics of the users of the machine learning models and temporal change of user behavior (as one example of concept drift of machine learning models, as described in further detail below).

As a particular example, the automated MLMM framework above may include technical components that facilitate detection and correction of concept drift of a machine learning model in the production environment. Specifically, development and training of a machine learning model may rely on a set of rules, relationship, and assumptions. Such rules, relationship, and distribution may change or shift over time, leading to a drop in the performance of the machine learning models over time. In some aspect, the real time input data distributions and/or underlying data relationship may change or shift away from those of the original training dataset. As a result, the trained machine model may become stale and inaccurate in predicting the target variables for new incoming data items. For example, in a machine learning model for predicting whether a user (input data) would click (target variable) a particular online advertisement (input data), the input data distribution such as demographics of the users may shift over time, e.g., the population may age (the portion of elderly increases) over time, and the underlying data relationship such as user behavior (likelihood of click an online advertisement) of a particular demographic group may evolve over time. Such changes, shifts, or evolution of the underlying data distribution or data relationship, referred to as concept drift, may lead to decrease in predictive accuracy of the machine learning model. Such predictive performance decrease may be detected by the MLMM framework. The machine learning model may be retrained based on updated training data, rules, and model assumptions. Further details for handling concept drift of machine learning models in the MLMM framework are included in the U.S. Provisional Patent Application No. 62/963,961, filed on Jan. 21, 2020, the entirety of which is herein incorporate by reference.

As another particular example, regardless of their types, purposes, and inner workings, machine learning models in production may be exposed to security threats in the form of, e.g., adversarial attacks. Such in-production adversarial attacks may include but are not limited to various types of attacks such as evasion, poisoning, trojaning, backdooring, reprograming, and inference attacks. An adversarial attack may be general-purpose or may specifically target a particular machine learning model or a particular machine learning architecture or algorithm. An adversarial attack may incorporate adversarial noises to input data aimed at inducing untargeted mis-prediction, or targeted mis-prediction, and/or reducing the confidence level of the machine learning model. A machine learning model may be built to be safe against some known priori adversarial attacks during the training stage. However, it is difficult to consider all priori adversarial attacks, and unknown new adversarial attacks may be developed by hackers after the machine learning model is placed in a production environment. A machine learning model in a production environment thus may be vulnerable to various types of existing and new adversarial attacks. The automated MLMM framework above may include various components for detecting known or unknown adversarial attacks in the input data and for further providing retraining and updating of the machine learning model to render the adversarial attach ineffective. Further details for handling adversarial attacks on machine learning models in the MLMM framework are included in the U.S. Provisional Patent Application No. 62/966,410, filed on Jan. 27, 2020, the entirety of which is herein incorporate by reference.

As another particular example, the automated MLMM framework above may include technical components that provide explainable reasoning behind the predictions of a machine learning model. Such explainability provides the logic behind predictive decisions made by the machine learning model and allows for human interactions, collaboration, and model sensitivity analysis through “what-if” algorithms. For example, these technical components may be designed to analyze prediction results corresponding to an input dataset and derive factors and features in the input dataset that contribute the most to the prediction results. These technical components may further provide capability to perform “what-if” analysis, in which some aspects of the input data may be modified for new predictions and the new predictions may be further analyzed to provide counter-factual reasoning.

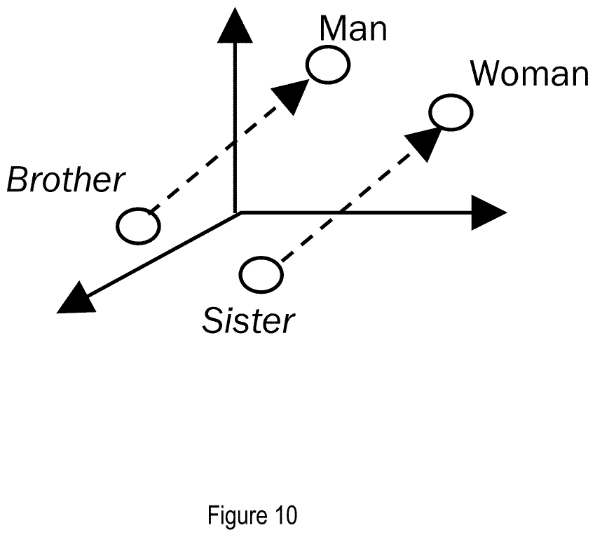

As yet another particular example, the automated MLMM framework above may include technical components that provide detection, testing, quantification, and removal of bias in the prediction outcome of the machine learning model. Fairness of the machine learning model may thus be improved. For example, a machine learning model embedded with word/document/language processing algorithms may be used by recruiters to identify resumes of job applicants that match or qualify for a particular job advertisement. In one example, the machine learning model may give high scores to a set of resumes associated mainly with male job applicants in response to a search for, e.g., a computer programmer. The technical components of the MLMM framework related to bias detection may be designed to detect whether such male-dominant output is biased (due to, e.g., gender-biased language algorithms used in the machine learning model) or unbiased (e.g., the male dominant results are related to dominance of male applicants and their true qualification). Detailed example implementations are provided below in relation to FIGS. 10-13.

The various technical components of the automated MLMM framework may be designed and integrated to provide model surety in the various aspects described above. As a result, the MLMM framework provides data integrity and model governance and may be configured to provide transparency, fairness, consistency, and robustness in the predictive behavior of the machine learning models. These machine learning models may be updated to be resilient against existing and future adversarial attacks and be adaptive against concept drift in machine learning models.

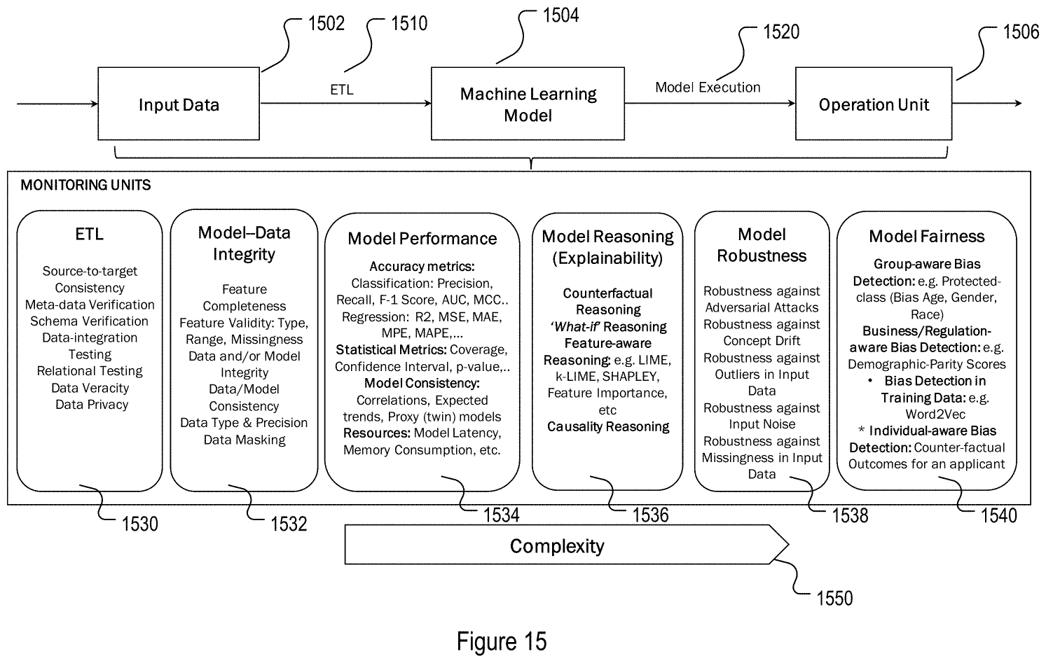

FIG. 15 shows an example architecture of a key monitoring circuitry of the MLMM framework. The monitoring circuitry is comprised of a plurality of tiered monitoring and testing units which either passively or actively monitor, test, or verify different points in the operation pipeline of the machine learning models. The monitoring circuitry is configured to control the plurality of monitoring and testing units to apply specific testing procedures at specified points in the operations pipeline, where example monitoring and testing units are shown to each belong to one of a predetermined complexity level among a plurality of complexity levels as shown in FIG. 15. Details of various implementations depend on the complexity level of choice.

These various technical components may be provided in a modular fashion for integration in any implementation of the MLMM. For example, the monitoring and testing may be performed on any of the input data 1502, machine learning model 1504, and operating unit 1506 as consumer of the machine learning model. Monitoring and testing may also be performed on ETL processes for input data, shown in 1510, and model execution process, shown as 1520. The monitoring and testing may be performed on ETL, model-data integrity, model performance, model reasoning or explainability, model robustness, and model fairness, shown by 1530, 1532, 1534, 1536, 1538, and 1540, respectively, with increasing algorithm complexity, as shown by arrow 1550.

The monitoring and testing units 1530 for ETL, for example, may be configured to perform, for example, source-to-target data consistency, meta-data verification, schema verification, data integration, relational, data veracity, and data privacy monitoring and testing. The model-data integrity monitoring and testing units 1532 for model-data integrity may be configured to perform, for example, feature completeness, feature validity (including types, range, missingness), data and/or model integrity, data-to-model consistency, data type and precision, and data masking monitoring and testing. The model performance monitoring and testing units 1534 may be configured to perform, for example, accuracy metrics monitoring and testing such as classification precision, classification recalls, regression, statistical metrics monitoring and testing such as coverage, confidence interval, p-value, model consistency monitoring and testing such as correlations, expected trends, proxy models, and resource monitoring and testing such as model latency, memory consumption, etc. The model reasoning/explainability monitoring and testing units 1536 may be configured to perform, for example, counterfactual reasoning, “what-if” reasoning, feature-aware reasoning (such as LIME, k-LIME, SHAPLEY, and causality reasoning). The model robustness monitoring and testing units 1538 may be configured to perform, for example, monitoring and testing of robustness against adversarial attacks, concept drift, outliers in input data, input noise, and missingness in input data. The model fairness monitoring and testing units 1540 may be configured to perform, for example, group-aware bias detection (such as gender, age, and racial bias), business/regulation-aware detection (such as demographic parity test in a loan application approval model), detection of bias in training data (bias due to pretrained language model, for example), and detection of individual-aware bias such as counter-factual individual outcome from a machine learning model.

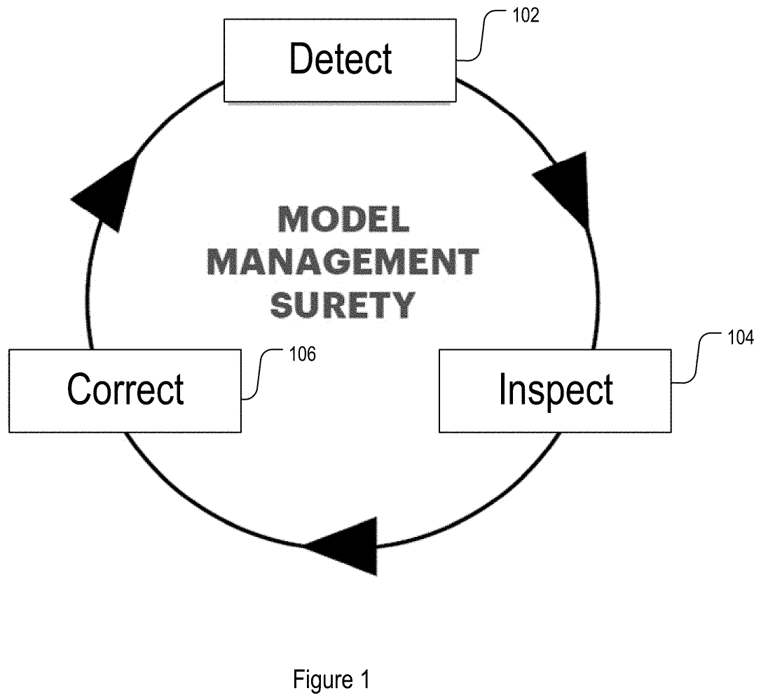

The various units above and other technical components may be provided as plug-ins of the automated MLMM framework. As shown in FIG. 1, these technical components of the MLMM framework may generally fall into functional categories including but not limited to detection circuitries or components (102), inspection circuitries or components (104), and correction circuitries or components (106). The detection circuitries 102 may be designed as intelligent agents for identifying and predicting various types of anomalies, malfunctions, and weaknesses in datasets and performance of the machine learning models. The inspection circuitries 104 may be designed for mathematical, statistical and functional investigation and analysis of potential problems that may cause unexpected machine learning model behaviors. The correction circuitries 106 may be designed for automated or semi-automated processing of machine learning models to improve, correct, replace, or escalate detected issues with the machine learning models. The term “circuitry” and “component” are alternatively referred to as “module” in this disclosure.

The MLMM framework of FIG. 1 may be designed to detect issues and inspect the issues on live data fed to the production machine learning models. As described in further detail below, the detection of issues with the machine learning models may be performed using, for example, a flexible ensemble detection scheme using, multiple parallel detection algorithms or schemes. The correction of the issues with the machine learning models may be triggered using an on-demand architecture or pipeline.

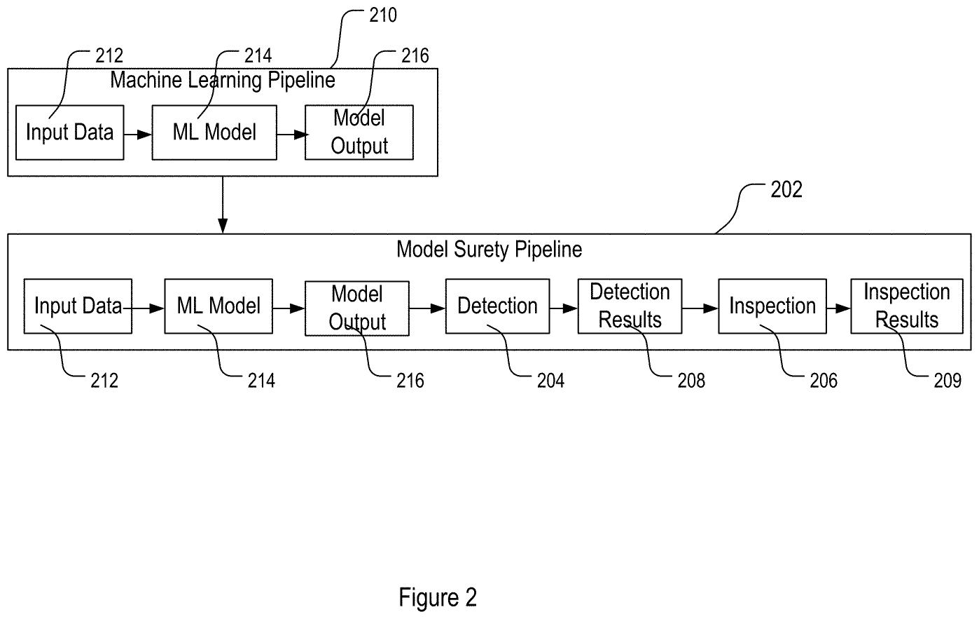

For example, as shown in FIG. 2, the MLMM framework may be implemented as a model surety pipeline 202 by embedding detection circuitries 204 and inspection circuitries 206 into a conventional production machine learning pipeline 210 that includes circuities 212 and 214 for receiving input data and for executing the machine learning model to obtain prediction outputs 216, respectively. The detection circuitries 204 and inspection circuitries 206 may be configured as add-ons to the conventional production machine learning pipeline 210 and does not need to interfere with any steps in the conventional machine learning pipeline 210.

The detection circuitries 204 may generate detection results 208, which may be processed by the inspection circuitries 206 to generate inspection results 209. The detection circuitry 204 and the inspection circuitries 206 thus augment the production machine learning pipeline 210 to determine that there are no issues occurring during model execution on live input data, and if there are issues, these issues would be identified. The detection circuitries 204, in particular, analyze the model output 216 of the live input data to determine if the model results 216 are trustworthy. If the model results 216 are trustworthy, the results 208 from the detection circuitries are further inspected by the inspection circuitries 206 to ensure consistency in the detection of issues with the machine learning model. The surety circuitries 202 including the detection circuitries 204 and the inspection circuitries 206 may support various levels of machine learning models, referred to as surety machine learning models, or surety models for simplicity. Like the machine learning models in the production machine learning model pipeline 210, the surety machine learning models may be trained, and further, may be evaluated, retrained and updated as described below.

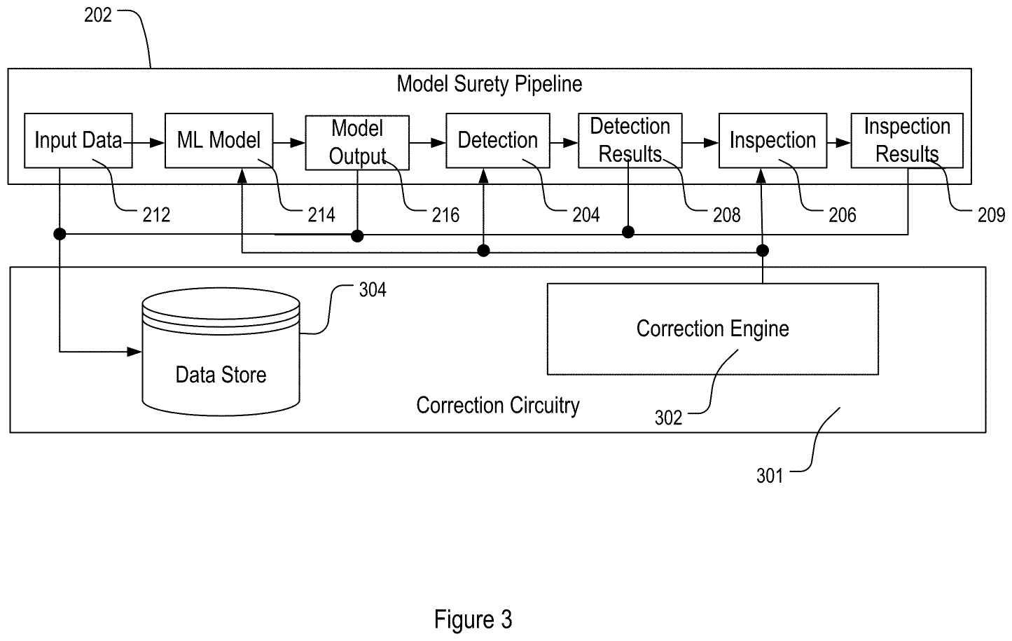

Correction circuitries may be further added to the model surety pipeline 202 of FIG. 2, as shown in FIG. 3, to provide the correction functionality of the MLMM framework as illustrated in FIG. 1. The correction circuitries may be alternatively referred to as correction clinic 301 in FIG. 3. In the example implementation shown in FIG. 3, the correction circuitries 301 may primarily reside outside of the main model surety pipeline 202. This is because corrections to the real time input data, machine learning models in the production pipeline 210, or the components of the surety pipeline such as the surety machine learning models described above (e.g. model retraining) may not be performed during live execution of the production machine pipeline. Instead, one or more flags are triggered via the detection circuitries 204 and the separate correction circuitries or clinic 301 outside of the surety pipeline 202 is run.

As further shown in FIG. 3, the correction circuitries 301 may include for example a correction engine 302 and data store 304. The correction engine 302 constitutes the main functionalities of the correction circuitries 301. The data store 304 may be included for handling various input data at 212, model output data 216, detection result 208 and inspection result 209 from the model surety pipeline 202, as well as various intermediate data that may be needed by the correction engine 302. These data are utilized by the correction engine 302 for making on-demand corrections and updates to the machine learning models in the model surety pipeline 202.

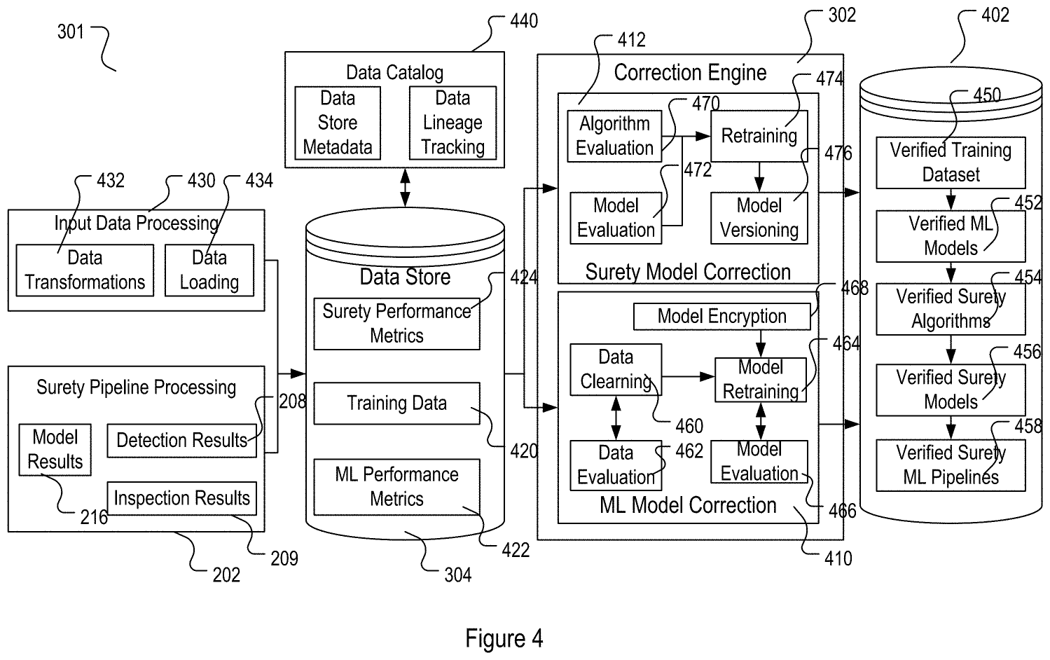

FIG. 4 shows an example architecture for the correction circuitry 301 of FIG. 3. As shown in FIG. 4, the correction engine 302 of the correction circuitries 301 takes its input data from the data store 304, and produces various outputs collectively referred to as model catalog 402. The correction engine 302 may include two technical components including a machine learning model correction component 410 for retraining of the various machine learning models that may be used for updating the corresponding machine learning models in the production surety pipeline 202 of FIGS. 2 and 3, and a surety model correction component 412 for correcting and updating various models used for the detection circuitries 204 and inspection circuitries 206 of the surety pipeline 202 in FIGS. 2 and 3.

The data store 304 may act as a repository for various data needed for the correction engine 302. Such data from the data store 304 are used either by the machine learning model correction component 410 for generating updated machine learning models or by the surety model correction engine 302 for generating updated surety machine learning models such as detection models and inspection models. Various data supplied by the data store 304 to the correction engine 302 may or may not be shared by the machine learning model correction component 410 and the surety model correction component 412. The data from the data store 304, for example, may include but are not limited to training data 420, machine learning model performance metrics data 422, and surety model performance metrics data 424. The training data 420 includes datasets for retraining of the machine learning models and the surety models (the various models used by the detection circuitries 204 and inspection circuitries 206). The data store 304 maintains an updated and corrected version of the training datasets that, for example, include the datasets used for original training of the machine learning models and the surety models, and live data processed by the surety pipeline of FIGS. 2 and 3 and labeled in real time. The machine learning model performance metrics data 422 may include, for example, acceptable performance threshold for triggering machine learning model evaluation and retraining, and performance data of the machine learning model as indicated by or derived from the prediction output of the production machine learning models. Likewise, the surety model performance metrics data 424 may include, for example, acceptable performance threshold for triggering surety model evaluation and retraining, and performance data of the surety model in correctly identifying the issues in the production machine learning models.

The data store 304 may be in communication with an input data processing component 430 as part of the correction circuitries 301 in real time, at predetermined times, or periodically. The input data processing component 430 may be configured to performing ETL of input data to the surety pipeline 202 of FIGS. 2 and 3. For example, the input data processing component 430 may include but is not limited to data transformation functions 432 and data loading functions 434. The output of the input data processing component 430 may be communicated to the surety pipeline. In addition, the output may be communicated to the data store 304, for updating, for example, the training datasets 420.

The data store 304 may further be in communication with the surety pipeline 202 in real time, at predetermined times, or periodically, to receive prediction output 216 based on the processed input data from the machine learning models in the surety pipeline 202, and the detection results 208 and the inspection results 209 from the detection circuitry 204 and the inspection circuitries 206 of the surety pipeline 202, respectively. These results are provided, for example, to the machine learning model performance metrics component 422 and the surety model performance metrics component 424 of the data store 304. An additional data catalog component 440 may be designed to manage and track the data contents in the data store 304. For example, the data catalog component 440 may include a metadata collection for the data store and data lineage tracking of the data store, as shown in 440.

The machine learning model correction component 410 of the correction engine is responsible for retraining of the machine learning models and communicating the updated models to the model catalog 402. The machine learning model correction component 410 may include data cleaning components 460 for cleansing the various training data and machine learning performance metrics data from the data store 304, data evaluation components 462 for analyzing the data, a model retraining component 464 for retraining of the machine learning models, a model evaluation component 466 for evaluating and testing the retrained machine learning models. The machine learning model correction component 410 may also include model encryption component 468 for encrypting the machine learning models using various model protection algorithms.

Likewise, the surety model correction component 412 of the correction engine is responsible for retraining of the surety models and communicating the updated surety models or algorithms to the model catalog 402. The surety model correction component 412 may include algorithm evaluation component 470 and model evaluation component 472 for evaluating and selecting various data analytics, modeling algorithms and surety models, a retraining component 474 for retraining of the surety models (including the detection modules and inspection modules), and a model versioning component 476 for controlling and managing various versions of the surety models.

The model catalog 402 may be configured as a model repository and log. The model catalog 402 may include various data, models, and algorithms. For example, the model catalog 402 may include verified training data set 450, verified machine learning models 452, verified surety algorithms 454, verified surety models 456, and verified surety machine learning pipelines 458. These verified data, algorithms, and models may be provided to other components of the MLMM via Application Programming Interface (API) and be incorporated into the surety pipeline 202.

Access to the various components of the correction circuitries 301 may be provided to various type of users through the MLMM. For example, access to these components may be provided via an API functions. These API functions may be integrated to provide applications and/or user interfaces for the various types of users of the MLMM. These users, for example, may include model engineers, data scientists, business analysts, and the like.

In some implementations, model engineers may be provided with user interfaces for configuring automated retraining of the machine learning models and surety models. For example, a model engineer may configure the surety pipeline 202 to detect noticeable drops in model accuracy, and then call a model retraining pipeline to generate a more robust model version. The model engineer thus (1) uses functionalities provided by the data store 304 for processing and fetching the latest training data, machine learning model results, detection results, (2) cleans the data and using the cleaned data to retrain the model and create a new model version via the correction engine 302, and (3) stores the new model in the model catalog 402 for access by any user on the same project.

In some implementations, data scientists may be provided with user interfaces for adding various algorithms to the model catalog 402 for use by the retrained machine learning models and the surety models. For example, a data scientist may be responsible for configuring the use of multiple detection algorithms for ensemble detection of issues in the machine learning models (e.g., ensemble detection of concept drift of the machine learning models, as further described below), and may have discovered a new detection algorithm and wish to add the new detection algorithm to the detection circuitry 204. The data scientist may evaluate the code of the new detection algorithm and add the code to the detection circuitry 204, creating a new version of the detection module. The new version of the detection module is then added to the model catalog so other data scientists can reuse the more robust detect module on their projects.

In some other implementations, a business analyst may be provided with a verified surety pipeline when the business analyst commence project. For a specific example, the business analyst may start a new project to classify satellite images. The business analyst may begin by searching the model catalog to find verified machine learning models for satellite imagery and verified adversarial attack detection modules. The verified satellite imagery machine learning models and the detection modules are then sent to a model engineer, who configures them in a surety pipeline, views the results, and configures a retraining pipeline to automatically improve the machine learning models and detection models over time.

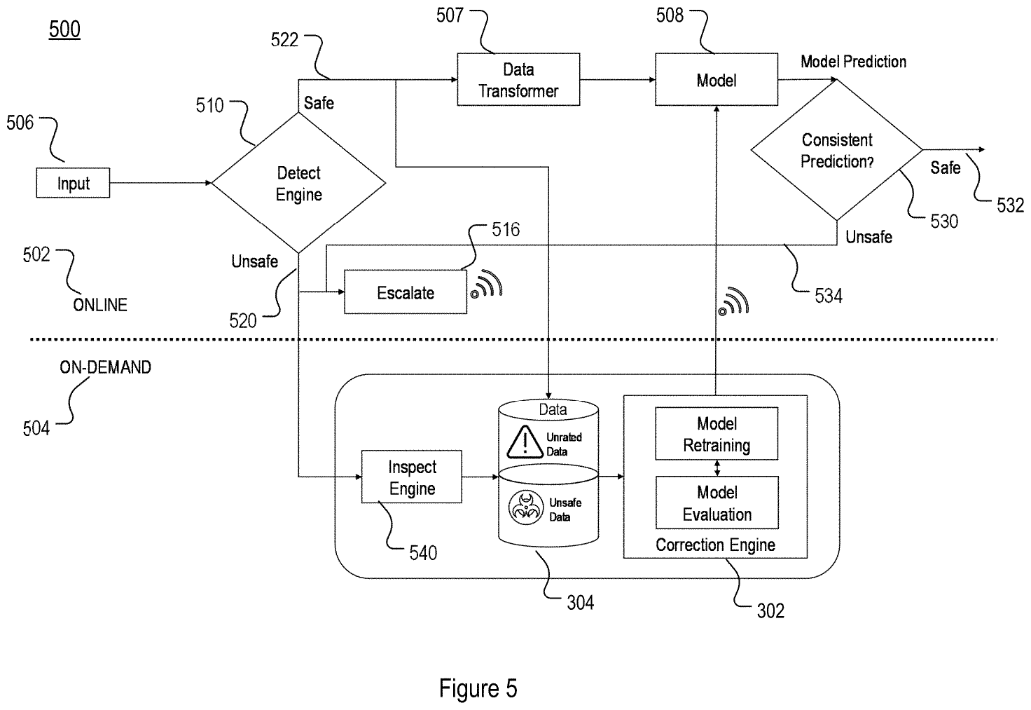

As shown in FIG. 5, the MLMM 500 may be divided into an online pipeline 502 and an on-demand pipeline 504 interacting with one another. In the example MLMM implementation 500 of FIG. 5, the online pipeline 502 is similar to that of the surety pipeline 202 of FIGS. 2 and 3, except that the inspection circuitry 206 are implemented mostly in the separate on-demand pipeline 504, and that the detection on live input data is performed prior to the running of the machine learning model in the online pipeline 502.

Specifically, the online pipeline 502 handles live data in real time, and may include three main example phases: detection phase (510), data transformation phase (507), and model execution phase (508). The detection phase 510 may be handled in a generalizable detection engine by analyzing the live input data 506 to the surety pipeline. The live input data enter the system and pass through the generalizable detection engine of the detection phase 510 first. For example, the detection engine may be configured to determine safety of the input data (e.g., whether the input data contains adversarial attacks). The generalizable detection engine may be designed and configured to be agnostic to the various machine learning models. From there the detection engine assesses the live input data as either “safe” or “unsafe”. If the detection engine in the detection phase 510 determines that the live input data is “unsafe” for the machine learning model to run on, data transformation and model execution phases as indicated by 507 and 508 are not run. Instead, an alert may be generated through the escalation process as indicated by 516, the input data and the assessment information by the detection phase 510 are made available via, e.g., API, and an on-demand inspection of the input data may be triggered, as shown by the arrow 520 crossing from the detection phase 510 to the on-demand pipeline 504.

Otherwise, as shown by the arrow 522, if the data is “safe” according the detection engine of the detection phase 510, the online pipeline 502 continues to the data transformation phase 507 and the machine learning model execution phase 508 with the live input data 506. The data transformation phase 507 is responsible for performing any necessary data transformations and normalization before proceeding to model execution. Such data transformation, for example, may include but is not limited to feature squeezing for image data, tokenization for text data, data normalization, outlier handling, or anything else that facilitates pre-processing of the live input data prior to the execution of the machine learning model. In some implementations, regardless of which decision the detection engine in the detection phase 510 makes, the data returned by the detection engine may be made available for all other stages and components of the MLMM to consume via API.

In the example implementation of FIG. 5, the online pipeline 502 further includes an optional engine for evaluating consistency of the prediction of the machine model, as indicated by 530. The prediction consistency evaluation engine 530 may be utilized as, e.g., a secondary precautionary adversarial detection engine. The output of the machine learning model, after execution by the model execution phase 508 may be passed to the prediction consistency evaluation engine 530, which then compares the results against results returned by an ensemble of proxy models of various architectures. If no significant difference in the results is observed, the prediction of the online machine learning model is considered safe, as shown by arrow 532. Otherwise, the prediction is flagged as ‘unsafe’ and may be escalated, as shown by arrow 534. An alert of inconsistency may be sent via API and received by any other components of the MLMM system. More details of such an online and on-demand pipeline architecture for the MLMM are described in U.S. Provisional Patent Application No. 62/966,410, filed on Jan. 27, 2020, the entirety of which is herein incorporate by reference.

The on-demand pipeline 504 of FIG. 5 may be configured to perform the function of inspection circuitry 206 and the correction circuitry 301 of FIGS. 2, 3, and 4. The on-demand pipeline 504 interacts with the online pipeline 502 to receive output from the detection phase 510, the prediction output from the model execution phase 508, the input data directly or through the detection phase 510, and the output from the optional prediction consistency evaluation engine 530, as shown be the various arrows between the online pipeline 502 and the on-demand pipeline 504.

The on-demand pipeline 504 maybe configured to be triggered by the generalizable detection engine in the detection phase 510 of the online pipeline 502, which may be configured to be agnostic to the machine learning models in production (or in the online pipeline). When the detection engine, for example, detects incoming data samples as adversarial above a given confidence threshold, the on-demand pipeline 504 may be triggered. The triggering of the on-demand pipeline 504 and the escalation and alerting functions indicated by 516 of the online pipeline are not mutually exclusive. Alert may be sent to relevant components in the MLMM and/or parties for manual intervention while the on-demand pipeline 504 may be automatically triggered.

The on-demand pipeline 504 handles further inspection and correction of issues with the data or model via an inspection engine 540 and the correction circuitries (including the data store 304 and the correction engine 302). The correction engine 302, as describe above in relation to FIG. 4, and for an example correction of adversarial attacks, can utilize an ensemble of model correction techniques, i.e. removing ‘bad’ data samples, retraining, and using proxy models. The retrained model may then be used to replace the corresponding production machine learning model in the online pipeline 502. In addition, the detection engine in the detection phase 510 of the online pipeline 502 may also be updated, when, for example, a new adversarial attack is detected.

While the example online and on-demand pipeline architecture of FIG. 5 are described above in the context of concept drifts or adversarial attacks, the underline principles are applicable to detecting and correcting other issues in the production machine learning models. As described above, the detection engine, for example, may be configured to be generalizable and may be model agnostic. Further, the detection engine of the detection phase 510 in the example implementation of FIG. 5 is configured to determine whether the live input data is safe or unsafe and is thus placed before the data transformation phase 507 and the model execution phase 508. In some other applications, a detection engine may be placed after the model execution phase 508 for detecting issues with the machine learning models. The detection engine thus can be located at various stages of the online surety pipeline. The stages of the online pipeline refer to various data processing segments or locations along the online surety pipeline where outputs can be extracted and monitored. In some implementations, separate detection engines may be placed before the model execution for detection issues in the input live data and after the model execution for detecting issues with the output of the machine learning model. A number of detectors and the locations for these detectors may be flexibly configured.

In some implementations, the detection engines described above either before or after the execution phase of the machine learning model in the online pipeline 502 may be implemented with an ensemble of detector for improving detection accuracy and for a broader scope of detectable issues. Additionally or optionally, a particular production machine learning model in the online pipeline may also be implemented using an ensemble of machine learning models rather than a single machine learning model for processing input live data and to improve prediction accuracy. The ensemble of machine learning models for a particular task in the production online pipeline 502 may be selected from a machine learning model school (or a machine learning model library).

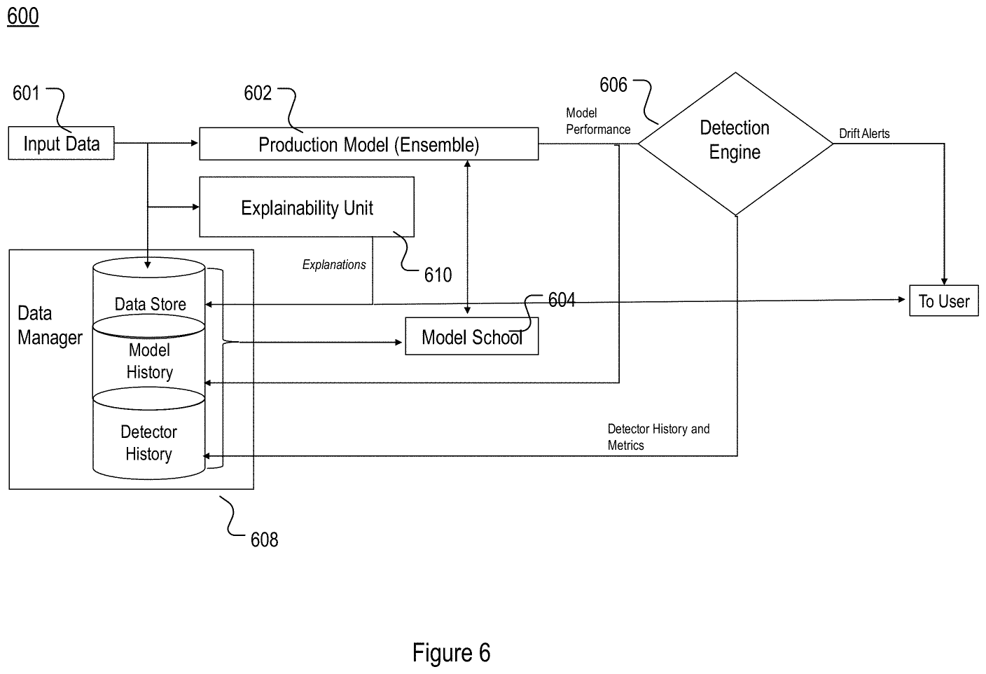

The use of ensemble detectors and/or ensemble of production of machine learning models is illustrated in FIG. 6. As shown in FIG. 6, the MLMM 600 may include an ensemble of production models 602 selected from model school 604 rather than a single machine learning model for prediction based in the live input data 601. The outputs of the production model ensemble 602 are provided to the detection engine 606 for further detecting issues with the production model ensemble 602. The detection engine 606 may further optionally contain an ensemble of detectors for more accurate and broader issue detection. The MLMM may also include an explainability unit 610 for deriving reasoning that may be correlated with the detection results provided by the detection engine 606. The MLMM further includes a data manager 608 for managing the data store, the machine learning models, and the detector models. For example, the machine learning models managed by the data manager 608 provide the basic library for the model school 604 for various machine learning tasks in production.

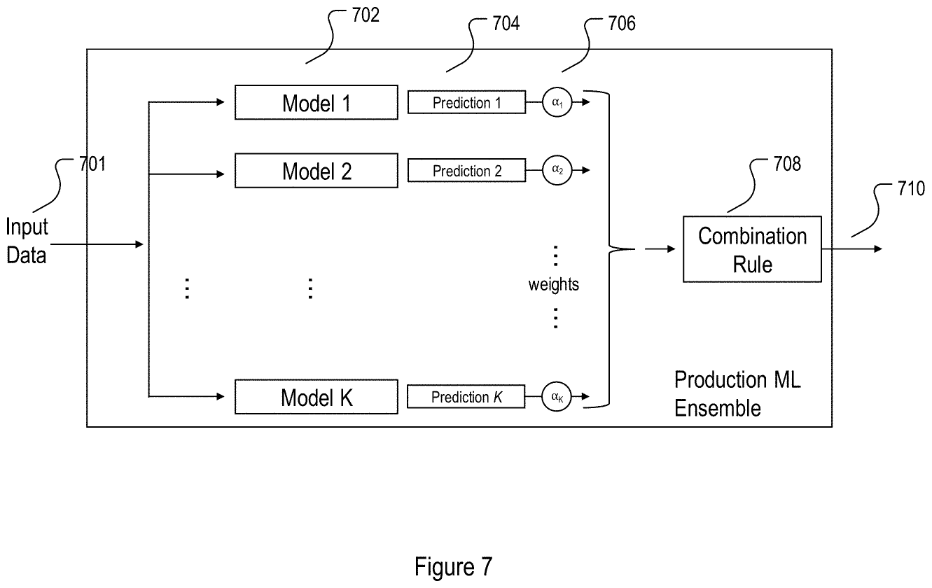

Using the production model ensemble selected from the model school 604 in the online pipeline improves accuracy of the model prediction. While such a model ensemble implementation is particular helpful for reducing impact on prediction accuracy due to concept drifts, it may be generally used to improve the performance of machine learning models against other issues faced by the machine learning models. The ensemble of models may be generated and trained using different model architectures, different model algorithms, different training data sets, and/or the like, to promote model diversity for improved overall prediction accuracy. FIG. 7 illustrates using a model ensemble to process a live input data 701 to make a collective prediction. As shown in FIG. 7, the machine learning models selected from the model school 604 of FIG. 6 form an ensemble of models 1, 2, . . . , and K (702), each generating a prediction (704). The predictions 704 of the models in the model ensemble 702 is weighted using configurable weights, as shown in 706 and processed using a configurable prediction combination rule set 708 to generate a single collective prediction 710.

The training of the various models in the model school 604 of FIG. 6 may be triggered by the detection engine (such as a concept drift detector) or on-demand request from human operators. Alternatively or additionally, the trigger for retraining of the model schools may be generated by a shadow learner. In some implementations, shadow learners may be configured with the explainability unit 610 of FIG. 6. Particularly in the concept drift context, the explainability unit 610 may be responsible for building shadow models (based on, for example, Hoeffding Trees or their variants such as Concept-Adapting Very Fast Decision Trees (CVFDT) to explain a detected concept drift. For example, CVFDTs may be built by the in the explainability unit 610 as a shadow model using the input data with labels. The CVFDTs may be built at various time frames. The change in the CVFDTs from time frame to time frame may be extracted to indicate the reasons for the detected concept drift. The output from the shadow learner may be processed for triggering the training of the models in the model school 604.

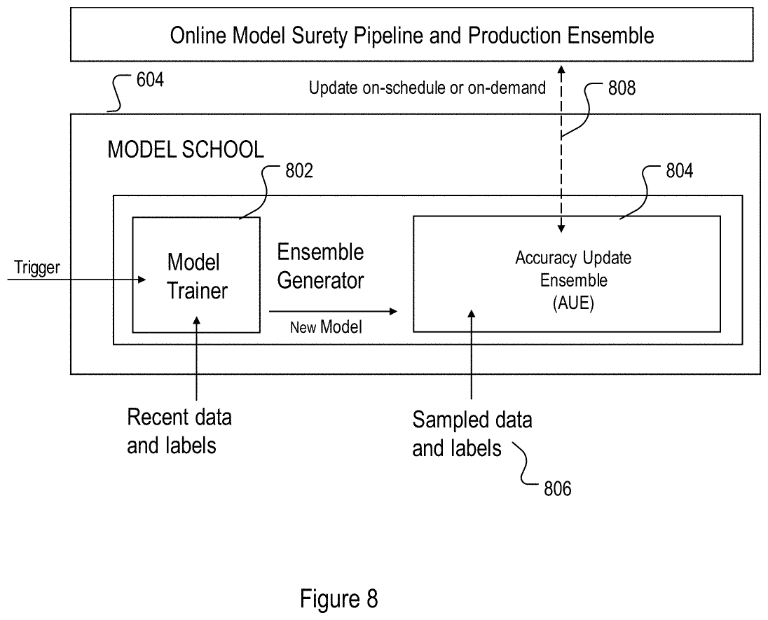

FIG. 8 illustrates the training process for the model school 604 of FIG. 6. As shown in FIG. 6, once triggered, the model school training process starts by invoking the model trainer 802, which receives recent data and labels as training dataset from the data store (e.g., 304 of FIG. 3). The model trainer 802 generates an ensemble of models including various new machine learning models. These models are then processed by an Accuracy Update Ensemble (AUE) component 804 (or any other ensemble technique such as dynamic majority votes) which may account for hardware limitation. In some implementations, the AUE component 804 may update the model assemble based on accuracy using sampled input data and labels, as shown by 806. The AUE component 804 may be responsible for updating the online model surety pipeline and the model ensemble therein based on accuracy, as shown by 808. The production ensemble may then be updated either on schedule or on-demand from operators. New models trained by the model trainer may be based on recent live input data and the labels generated, for example by an additional data labeler described in the U.S. Provisional Patent Application No. 62/963,961, filed on Jan. 21, 2020, and herein incorporated by reference.

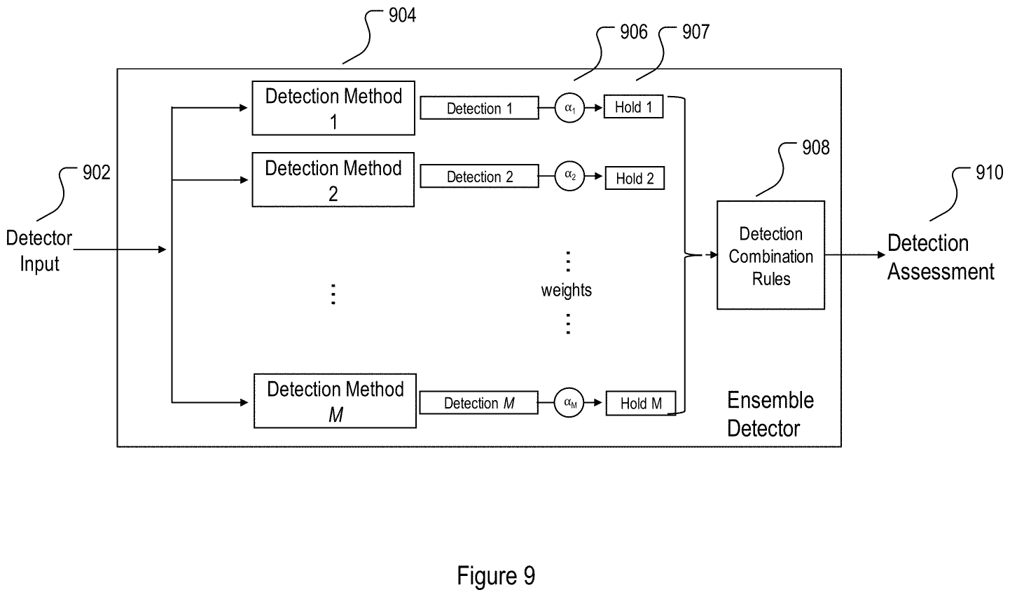

FIG. 9 further illustrates an ensemble detector 900 for detecting issues including multiple detection branches 904 for processing and detection of the input 902. The input 902 may include one or more of the input data to the machine learning model (labeled or unlabeled) and the prediction of the machine learning model. Each of the detection branches may use a different detection method, architecture, or algorithm. The prediction or detection results of the detection branches 904 may be weighted with configurable weights, as shown by 906, and then held (or delayed with configurable delays), as shown by 907. The weighed and delayed predictions of the various detection branches may be combined using a configurable combination rule set 908 to obtain a detection assessment 910. The combination rule set 908 may be based on, for example a business and/or technology-aware rule set. The combined detection assessment may be compared with a predetermined threshold. An alert may be generated if the combined detection assessment is above the predetermined threshold. Alternatively or additionally, a detection flag may be set. Escalation may be sent to other components in the MLMM and users of the MLMM. Further, the on-demand pipeline may be automatically triggered for inspection and for the correction circuitries and correction engine to evaluate and retrain the machine learning models or the surety models.

The ensemble approach above for the detection engine combines benefit of various single detection algorithms to provide more accurate and broader detection. It allows for a flexible detector with configurable design and complex optimization of various tunable parameters in the ensemble detector including detection accuracy/precision/sensitivity levels (for example, via the detection threshold) and delays between the various detection branches (the hold time 907). The individual detection algorithms can be chosen with diversity. For example, a concept drift detector ensemble may include various detection algorithms based on one or more of Drift Detection Method (DDM), Early Drift Detection Method (EDDM), Adaptive Windowing (ADWIN) detection, Page-Hinkely (P-H) statistical detection, and CUmulative SUM (CUSUM) detection, and the like.

Finally, the detection circuits or detection engines described above in relation to FIGS. 2, 3, 5, 6, and 9 may be configured to detect bias in the production machine learning models (a single machine learning model or an ensemble of machine learning models). The correction circuitry including the correction engine may be correspondingly configured to correct the machine learning models to remove the bias.

As an example, FIG. 10 illustrates an example feature space for vectorizing words using a language model. FIG. 10 illustrates a machine learning model showing appropriate unbiased relationship involving gender. In this example, input “brother”, “sister”, “man”, and “woman” are placed by the machine model in the feature space with correct gender relationship, represented by the identical vector shift from the coordinate of “brother” and “sister” to “man” and “women” in the feature space, respectively. Such a relationship in the feature space does not contain any gender bias.

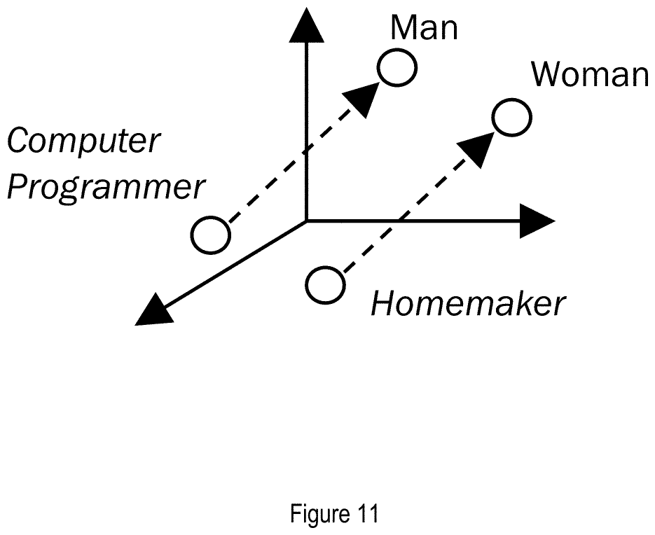

As further shown in FIG. 11, however, when the machine learning model produces similar relationship between “computer programmer” and “man”, and between “homemaker” and “women”, such relationship may potentially result from a gender bias in the machine learning model. Such bias may originate from a gender bias in a language model used in the machine learning model to generate the various feature vectors shown in FIG. 11. The task of a bias detector of the MLMM is to detect and identify such bias. Detecting bias can be implemented in various manners. For example, in language models, bias can be detected by using a set of labeled unbiased relationships between different words based on their vectorized representation derived from a language model like Word2Vec. For example, “he”→“man” and “she”→“woman” vector relationships are labeled as acceptable. This can be implemented as four mathematical vectors for these four words. These relationships can be used as base-set and as a ‘beacon’ to measuring how ‘biased’ relationships of interest amongst words are (such as relationship between “he”→“programmer” and “she→nurse”).

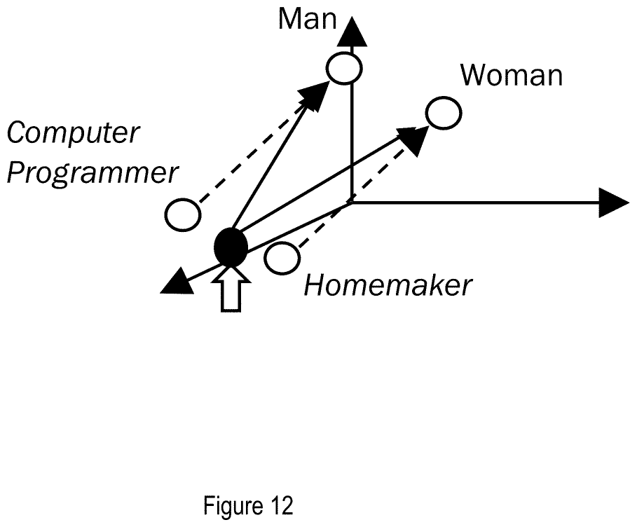

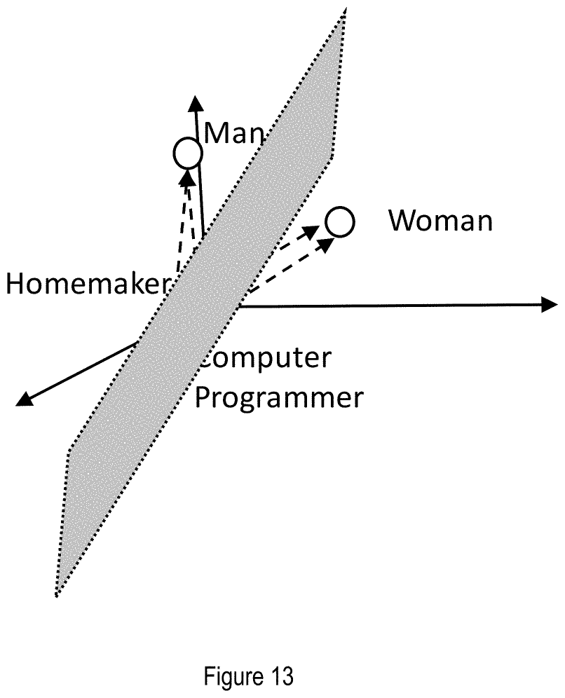

The correction circuitry and correction engine is to retrain the machine learning models to remove the bias. For example, as shown in FIG. 12, a machine learning model without inappropriate gender bias should convert the words in “computer programmer” and “Homemaker” into vectors that take distinct transformation towards “man” and “women” in the feature space, respectively. In some example implementations, the correction circuitry or correction engine may remove the bias by defining a feature subspace that remove the vector's projection on this subspace if the vector (e.g., software engineer or homemaker) is not supposed to be skewed towards one gender or another, as shown in FIG. 13.

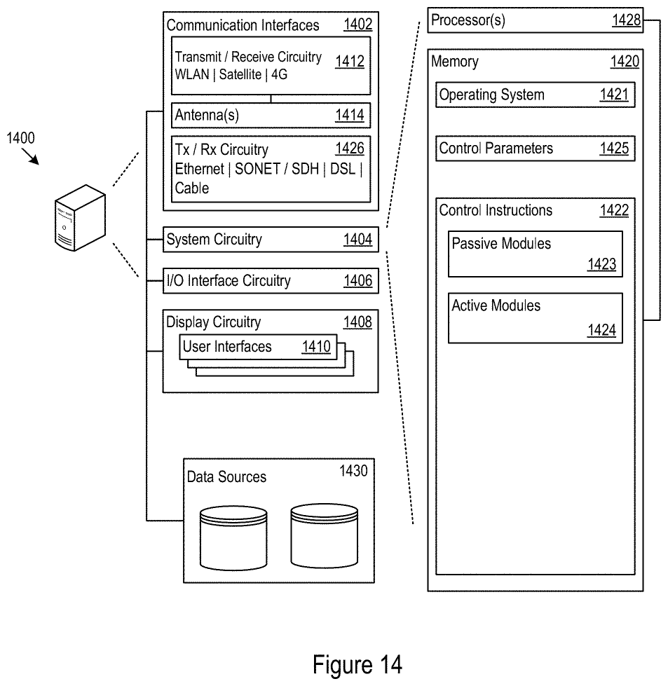

The various technical components above for the MLMM may be implemented using any types of computing devices. FIG. 14 illustrates an exemplary computer architecture of a computer device 1400. The computer device 1400 includes communication interfaces 1402, system circuitry 1404, input/output (I/O) interface circuitry 1406, and display circuitry 1408. The graphical user interfaces (GUIs) 1410 displayed by the display circuitry 1408 may be representative of GUIs generated by the MLMM tool to, for example, apply one or more active or passive modules (e.g., testing modules) to the operational pipelines of the machine learning models in production. The graphical user interfaces (GUIs) 1410 displayed by the display circuitry 1408 may also be representative of GUIs generated by the MLMM tool to receive user command inputs to, for example, apply corrective measures for correcting issues detected by the MLMM tool. The GUIs 1410 may be displayed locally using the display circuitry 1408, or for remote visualization, e.g., as HTML, JavaScript, audio, and video output for a web browser running on a local or remote machine. Among other interface features, the GUIs 1410 may further render displays of visual representations of the operational pipelines of the machine learning models in production. By including the GUIs 1410 that display the visual representations of the operational pipelines of the machine learning models in production, a simple drag and drop feature for applying the different modules to different stages in the operational pipelines may be provided.

The GUIs 1410 and the I/O interface circuitry 1406 may include touch sensitive displays, voice or facial recognition inputs, buttons, switches, speakers and other user interface elements. Additional examples of the I/O interface circuitry 1406 includes microphones, video and still image cameras, headset and microphone input/output jacks, Universal Serial Bus (USB) connectors, memory card slots, and other types of inputs. The I/O interface circuitry 1406 may further include magnetic or optical media interfaces (e.g., a CDROM or DVD drive), serial and parallel bus interfaces, and keyboard and mouse interfaces.

The communication interfaces 1402 may include wireless transmitters and receivers (“transceivers”) 1412 and any antennas 1414 used by the transmit and receive circuitry of the transceivers 1412. The transceivers 1412 and antennas 1414 may support WiFi network communications, for instance, under any version of IEEE 802.11, e.g., 802.11n or 802.11ac, or other wireless protocols such as Bluetooth, Wi-Fi, WLAN, cellular (4G, LTE/A). The communication interfaces 1402 may also include serial interfaces, such as universal serial bus (USB), serial ATA, IEEE 1394, lighting port, I²C, slimBus, or other serial interfaces. The communication interfaces 1402 may also include wireline transceivers 1416 to support wired communication protocols. The wireline transceivers 1416 may provide physical layer interfaces for any of a wide range of communication protocols, such as any type of Ethernet, Gigabit Ethernet, optical networking protocols, data over cable service interface specification (DOCSIS), digital subscriber line (DSL), Synchronous Optical Network (SONET), or other protocol.

The system circuitry 1404 may include any combination of hardware, software, firmware, APIs, and/or other circuitry. The system circuitry 1404 may be implemented, for example, with one or more systems on a chip (SoC), application specific integrated circuits (ASIC), microprocessors, discrete analog and digital circuits, and other circuitry. The system circuitry 1404 may implement any desired functionality of the MLMM tool. As just one example, the system circuitry 1404 may include one or more instruction processor 1418 and memory 1420.

The memory 1420 stores, for example, control instructions 1422 for executing the features of the MLMM tool, as well as an operating system 1421. In one implementation, the processor 1418 executes the control instructions 1422 and the operating system 1421 to carry out any desired functionality for the MLMM tool, including those attributed to passive modules 1423 (e.g., relating to monitoring of ML models), and/or active modules 1424 (e.g., relating to applying adversarial attack tests or verifying a ML model's robustness). The control parameters 1425 provide and specify configuration and operating options for the control instructions 1422, operating system 1421, and other functionality of the computer device 1400.

The computer device 1400 may further include various data sources 1430. Each of the databases that are included in the data sources 1430 may be accessed by the MLMM tool to obtain data for feeding into a machine learning model.

As described above, the MLMM tool provides management, orchestration, and governance of machine learning models in their production environments. The MLMM tool further provides easy to deploy machine learning models, executes data pipelines feeding the machine learning models, provides pipelines of models where applicable, and retrieves and/or maintains a log of the results of the machine learning models. The MLMM tool further provides a modular approach to automatic or semi-automatic monitoring, testing, and/or correction of machine learning models in their production environments. The MLMM tool further provides a modular design and deployment of passive and/or active monitoring agents with feedback loops and result logging features. The MLMM tool further provides generalizable detection engines designed to verify machine learning models in production with transparent and adjustable complexity level, reasoning logic, and business requirement dependencies. The MLMM tool further provides automatic or semi-automatically aid for training machine learning models to become robust to outliers, missing data (data scarcity), concept drifts, or even instances of adversarial attacks. The MLMM tool optionally utilize ensemble techniques for the production machine learning models and/or the detection engine to provide enhanced prediction and detection accuracy. The MLMM tool provides features that detect ways to improve pipeline performance once machine learning models have already been deployed.

Various implementations have been specifically described. However, other implementations that include a fewer, or greater, number of features and/or components for each of the apparatuses, methods, or other embodiments described herein are also possible.

What is claimed is:

1. A computer system comprising:
an online production pipeline for a production machine learning model comprising:
a production pipeline for executing the production machine learning model to generate a prediction from a live input data item; and
a detection engine configured to monitor at one or more stages in the production pipeline a metric of the production pipeline and to generate a trigger signal when the monitored metric falls below a predetermined threshold; and
an on-demand pipeline in communication with the online production pipeline comprising:
a data store for receiving the live input data item, the monitored metric of the production pipeline, and the prediction of the production machine learning model from the online production pipeline;
a model library for storing machine learning models; and
a correction engine for generating a corrected machine learning model of the production machine learning model based on data maintained in the data store and for updating the model library and the production pipeline with the corrected machine learning model.

2. The computer system of claim 1, wherein the detection engine is configured to monitor the live input data item.

3. The computer system of claim 2, wherein the production pipeline is configured to bypass the execution of the production machine learning model when the detection engine determines that the monitored metric for the live input data item is below the predetermined threshold.

4. The computer system of claim 3, wherein the detection engine is configured to detect an adversarial attack in the live input data item.

5. The computer system of claim 1, wherein the detection engine is configured to monitor the prediction of the production machine learning model.

6. The computer system of claim 5, wherein the detection engine is configured to detect a concept drift of the production machine learning model.

7. The computer system of claim 1, wherein the detection engine is configured to monitor the live input data item and the prediction of the production machine learning model.

8. The computer system of claim 1, wherein the detection engine comprises an ensemble of a configuration number of detectors.

9. The computer system of claim 8, wherein the configuration number of detectors are configured to monitor the same live input data item or the same prediction of the production machine learning model and differ in at least detector architecture and detection algorithm.

10. The computer system of claim 8, wherein the metric of the production pipeline is generated by combining detection results of the configuration number of detectors using a configurable set of combination rules.

11. The computer system of claim 10, wherein the detection results of the configurable number of detectors are weighed using a configurable set of weights before being combined.

12. The computer system of claim 11, wherein the detection results of the configurable number of detectors are delayed with a configurable set of relative delays before being combined.

13. The computer system of claim 1, wherein the production machine learning model comprises an ensemble of a configurable number of production machine learning models.

14. The computer system of claim 13, wherein the prediction comprises a weighted combination of predictive results by the configurable number of production machine learning models from the live input data item.

15. The computer system of claim 13, wherein the configurable number of production machine learning models are selected from a model school.

16. The computer system of claim 15, wherein the model school is updated with retrained machine learning models by the on-demand pipeline upon receiving the triggering signal from the online production pipeline.

17. The computer system of claim 1, wherein the detection engine is configured to determine a bias in the production machine learning model and on-demand correction pipeline is configured to retrain the production machine learning model to reduce the bias.

18. The computer system of claim 17, wherein the on-demand pipeline is configured to identify biased relationship in a feature space of the production machine learning model and generate a feature subspace in the feature space that removes the biased relationship.

19. A method, comprising:
providing an online production pipeline for a production machine learning model comprising a production pipeline for executing the production machine learning model to generate a prediction from a live input data item; and a detection engine configured to monitor at one or more stages in the production pipeline a metric of the production pipeline and to generate a trigger signal when the monitored metric falls below a predetermined threshold; and
providing an on-demand pipeline in communication with the online production pipeline;
receiving, by the on-demand pipeline, the live input data item, the monitored metric of the production pipeline, and the prediction of the production machine learning model from the online production pipeline;
generating, by the on-demand pipeline, a corrected machine learning model of the production machine learning model based on the received live input data item, the monitored metric, and the prediction; and
updating a model library and the production pipeline with the corrected machine learning model.

20. A non-transitory computer readable medium for storing computer instructions, wherein the computer instructions, when executed by a processor, is configured to cause the processor to:
provide an online production pipeline for a production machine learning model comprising a production pipeline for executing the production machine learning model to generate a prediction from a live input data item; and a detection engine configured to monitor at one or more stages in the production pipeline a metric of the production pipeline and to generate a trigger signal when the monitored metric falls below a predetermined threshold; and
provide an on-demand pipeline in communication with the online production pipeline;
receive, by the on-demand pipeline, the live input data item, the monitored metric of the production pipeline, and the prediction of the production machine learning model from the online production pipeline;
generate, by the on-demand pipeline, a corrected machine learning model of the production machine learning model based on the received live input data item, the monitored metric, and the prediction; and
update a model library and the production pipeline with the corrected machine learning model.
